(19) United States
(12) Patent Application Publication
(10) Pub. No.: US 2023/0394802 A1
(43) Pub. Date: Dec. 7, 2023

(54) METHODS, APPARATUS, AND ARTICLES OF MANUFACTURE TO EXPLAIN MACHINE LEARNING MODELS

(71) Applicant: Intel Corporation, Santa Clara, CA (US)

(72) Inventors: Evgeny Tsykunov, Ottobrunn (DE); Wonju Lee, Seongnam-si (KR); Minje Park, Seongnam-si (KR)

(21) Appl. No.: 18/454,654

(22) Filed: Aug. 23, 2023

(51) Int. Cl. G06V 10/774; G06V 10/77

(52) U.S. Cl. CPC G06V 10/774; G06V 10/7715

(57) ABSTRACT

Systems, apparatus, articles of manufacture, and methods are disclosed to explain machine learning models. An example apparatus includes programmable circuitry to generate a bitmask having a kernel size, apply the bitmask to the input image to generate a first masked input image, and compute a first saliency score for a first pixel of an input image based on the first masked input image. Additionally, the example programmable circuitry is to compute a second saliency score for a second pixel of the input image based on an output generated by a machine learning model, the output based on a second masked input image. The example programmable circuitry is also to generate a saliency map for the input image based on the first saliency score and the second saliency score, the saliency map indicative of at least one feature of the input image that contributed to training of the machine learning model.

### FIELD OF THE DISCLOSURE

This disclosure relates generally to artificial intelligence and, more particularly, to methods, apparatus, and articles of manufacture to explain machine learning models.

### BACKGROUND

Artificial intelligence models, such as neural networks, are useful tools that have demonstrated value solving complex problems regarding pattern recognition, natural language processing, automatic speech recognition, etc. Neural networks operate, for example, using artificial neurons arranged into layers that process data from an input layer to an output layer, applying weighting values to the data during the processing of the data. Such weighting values are determined during a training process.

### BRIEF DESCRIPTION OF THE DRAWINGS

FIG. 1 is a block diagram of an explainable artificial intelligence (XAI) system to generate a saliency map for an input image processed by an artificial intelligence model.

FIG. 2 is a graphical illustration depicting example saliency maps generated by the XAI system of FIG. 1.

FIG. 3 is a graphical illustration depicting additional example saliency maps generated by the XAI system of FIG. 1.

FIG. 4 is a graphical illustration depicting further example saliency maps generated for detection of different objects in images.

FIG. 5 is a graphical illustration depicting yet other example saliency maps generated for classification of different images.

FIG. 6 is a graphical illustration depicting example performance of the XAI system of FIG. 1.

FIG. 7 is a flowchart representative of example machine readable instructions and/or example operations that may be executed, instantiated, and/or performed by example programmable circuitry to implement the XAI system of FIG. 1.

FIG. 8 is a block diagram of an example processing platform including programmable circuitry structured to execute, instantiate, and/or perform the example machine readable instructions and/or perform the example operations of FIG. 7 to implement the XAI system of FIG. 1.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIG. 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations. Many different types of machine learning models and/or machine learning architectures exist.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

Training is performed using training data. Additionally, training is performed using hyperparameters that control how the learning is performed (e.g., a learning rate, a number of layers to be used in the machine learning model, etc.). Once training is complete, the model is deployed for use as an executable construct that processes an input and provides an output based on the network of nodes and connections defined in the model. Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data).

In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.). In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

As described above, advances in AI allow machines to perform complex tasks that could previously only be performed by humans. As adoption of AI-powered systems increases, concerns about transparency and interpretability of AI models underlying the systems have grown. For example, the General Data Protection Regulation (GDPR) of the European Union (EU) and other guidelines for trustworthy AI have been introduced. Some such regulations and guidelines establish a right of explanation. A right of explanation requires that a user be able to be provided an explanation about decisions made based on their data. Consequently, there is a growing demand for explainable AI (XAI) systems that can provide a clear and understandable rationale for decisions made by underlying AI models.

The fundamental way of explaining an AI model is to determine which parts of an input contribute the most to the behavior of a model. For example, in the domain of computer vision, saliency maps have been widely used as a de facto standard of explanation. A saliency map is a measure of the spatial support of one or more features in an input image. In one example, a saliency map of an input image is an image that identifies a degree of importance of one or more pixels in the input image to an output generated by a machine learning model after processing the input image. For example, a saliency map indicates a feature of an input image that is relevant to the training of a machine learning model to classify the input image. While example saliency maps disclosed herein are described in the context of an image, any other type of data structure and/or data may additionally or alternatively be used. In such other examples, a saliency map may be represented by a data structure that identifies a degree of importance of one or more portions of a corresponding data structure to an output generated by a machine learning model.

Several white-box and black-box approaches have been proposed to generate saliency maps. White-box approaches are generally limited to specific neural network architectures and require the ability to compute gradients or access intermediate activations of a neural network. These limitations make white-box approaches unsuitable for post-deployment frameworks that exhibit optimized intermediate representations of trained models.

In contrast, black-box approaches do not suffer from such limitations. For example, black-box approaches treat a model as a complete black box and do not assume accessibility to parameters, features, or gradients of the model. To approximate a saliency map for a model, some black-box approaches utilize numerical methods, such as the Monte Carlo method, to perturb input images and analyze corresponding outputs to explain predictions generated by a model in a post-hoc manner. Additionally, some black-box approaches utilize gradient descent-based optimization to explain model behavior.

However, existing black-box approaches require hundreds or thousands of iterations to generate fine-grained saliency maps for models. As such, existing white-box and black-box approaches are not suitable for explaining AI models. For example, the hundreds or thousands of iterations can require several seconds of execution on specialized hardware (e.g., a graphics processing unit (GPU)) to generate a saliency map for a single input image. Such specialized hardware might not necessarily be available on devices where such saliency maps may be needed. Additionally, existing white-box and black-box approaches are too slow (e.g., existing white-box and black-box approaches can consume more than 10 seconds of execution on a GPU for a single image).

Examples disclosed herein include a fast and computationally efficient black-box approach to approximate saliency maps for input images to an AI model. Disclosed methods, apparatus, and articles of manufacture sample input images utilizing a bitmask to evaluate the contribution of pixels in an input image to the output of an AI model. Examples disclosed herein generate bitmasks based on an optimization objective. For example, methods, apparatus, and articles of manufacture disclosed herein include a derivative-free black-box XAI algorithm. Disclosed examples generate competitive saliency maps with a number of iterations that is an order of magnitude smaller as compared to the above-described black-box approaches. Thus, examples disclosed herein are suitable for building an efficient XAI application that is not limited to a specific model architecture and/or specific algorithm design.

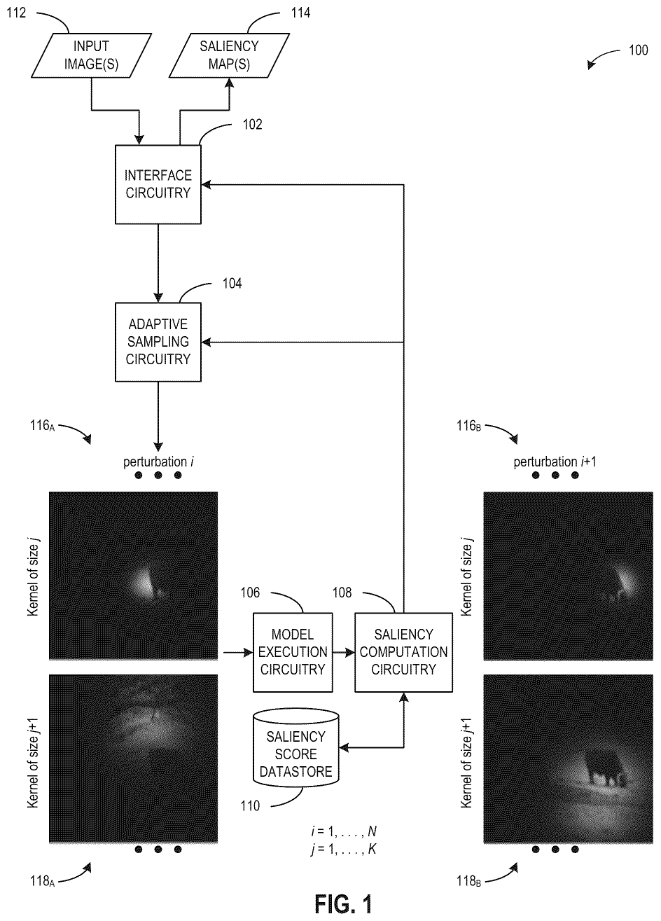

FIG. 1 is a block diagram of an explainable artificial intelligence (XAI) system 100 to generate a saliency map for an input image processed by an artificial intelligence model. For example, the XAI system 100 formulates saliency map generation as a kernel density estimation (KDE) problem with gradient-free adaptive sampling of bitmasks (e.g., adaptive sampling of bitmasks without access to gradients of a machine learning model). To implement KDE, the XAI system 100 utilizes a representative set of samples of bitmasks with a variety of kernel widths. For example, the XAI system 100 adaptively samples bitmasks using global optimization and applies several kernel widths simultaneously.

In the illustrated example of FIG. 1, the XAI system 100 includes example interface circuitry 102, example adaptive sampling circuitry 104, example model execution circuitry 106, example saliency computation circuitry 108, and an example saliency score datastore 110. In the example of FIG. 1, the XAI system 100 may be instantiated (e.g., creating an instance of, bring into being for any length of time, materialize, implement, etc.) by programmable circuitry such as a Central Processor Unit (CPU) executing first instructions. Additionally or alternatively, XAI system 100 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions.

It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

In the illustrated example of FIG. 1, the interface circuitry 102 is coupled to the adaptive sampling circuitry 104 and the saliency computation circuitry 108. Additionally, the interface circuitry 102 is in communication with one or more external devices (e.g., devices external to the XAI system 100). For example, the interface circuitry 102 accesses example one or more input images 112 to be processed by a machine learning model under analysis by the XAI system 100. In the example of FIG. 1, an input image (I) maps a domain (Ω) to the set of three-dimensional (3D) vectors of real numbers (R³ (e.g., I:Ω→ [symbol] ³). In the example of FIG. 1, the domain (Ω) is based on the height (H) and width (W) of the image (I) (e.g., Ω={0, . . . , H−1}×{0, . . . , W−1}).

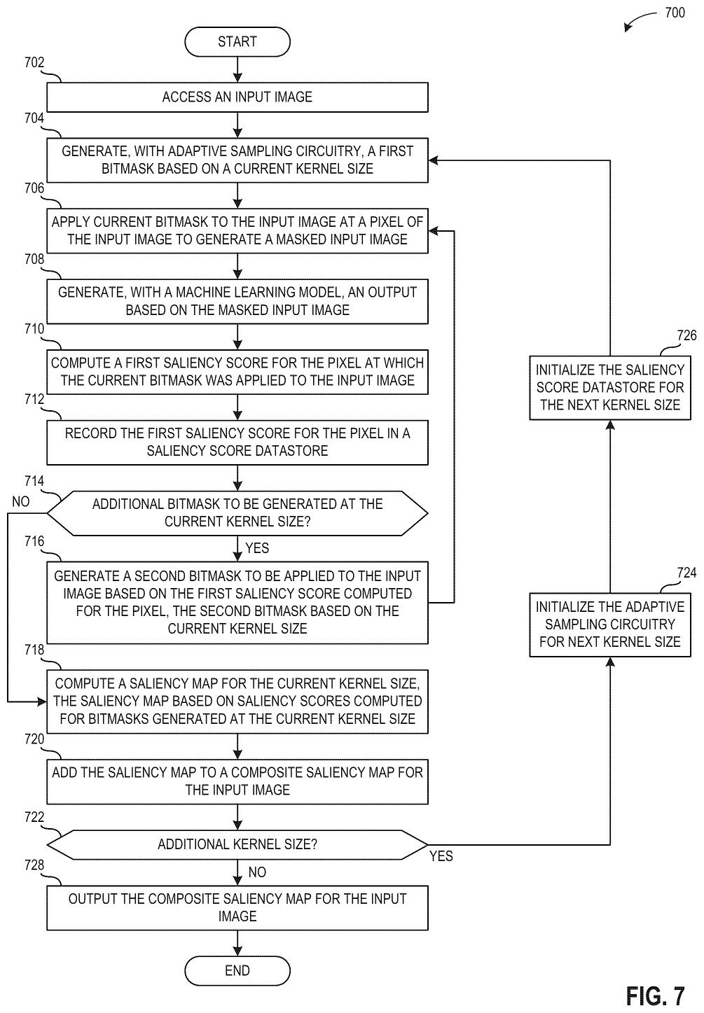

In the illustrated example of FIG. 1, after the XAI system 100 has generated one or more saliency maps 114 for the one or more input images 112 processed by a machine learning model, the interface circuitry 102 outputs the one or more saliency maps 114. For example, the interface circuitry 102 can transmit a saliency map for an input image to a device that provided the input image to the XAI system 100. In some examples, the interface circuitry 102 accesses a machine learning model to be executed by the model execution circuitry 106. In some examples, the interface circuitry 102 is instantiated by programmable circuitry executing interfacing instructions and/or configured to perform operations such as those represented by the flowchart(s) of FIG. 7.

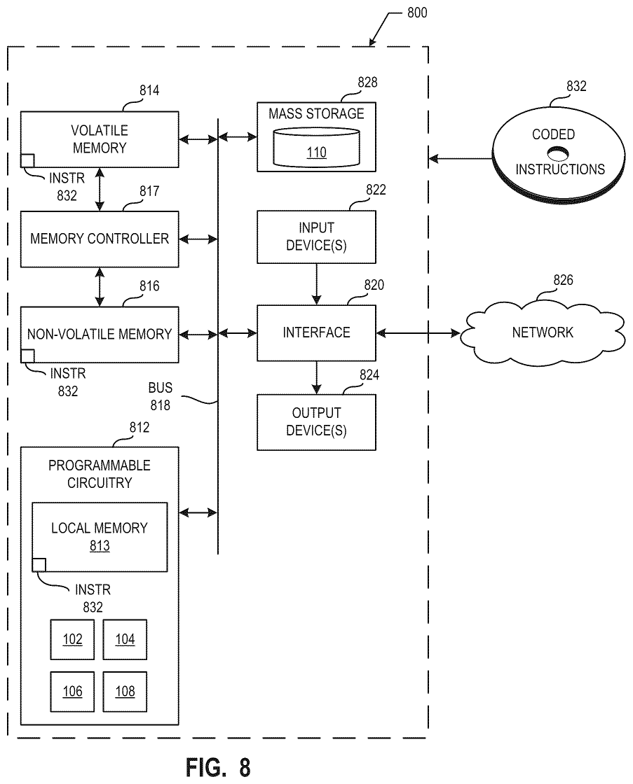

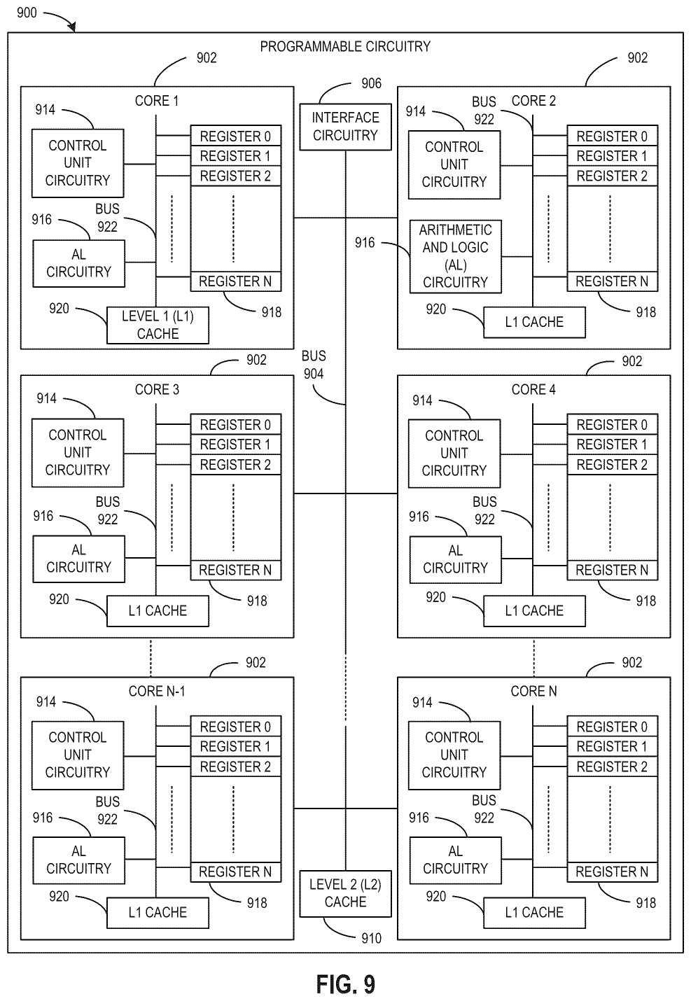

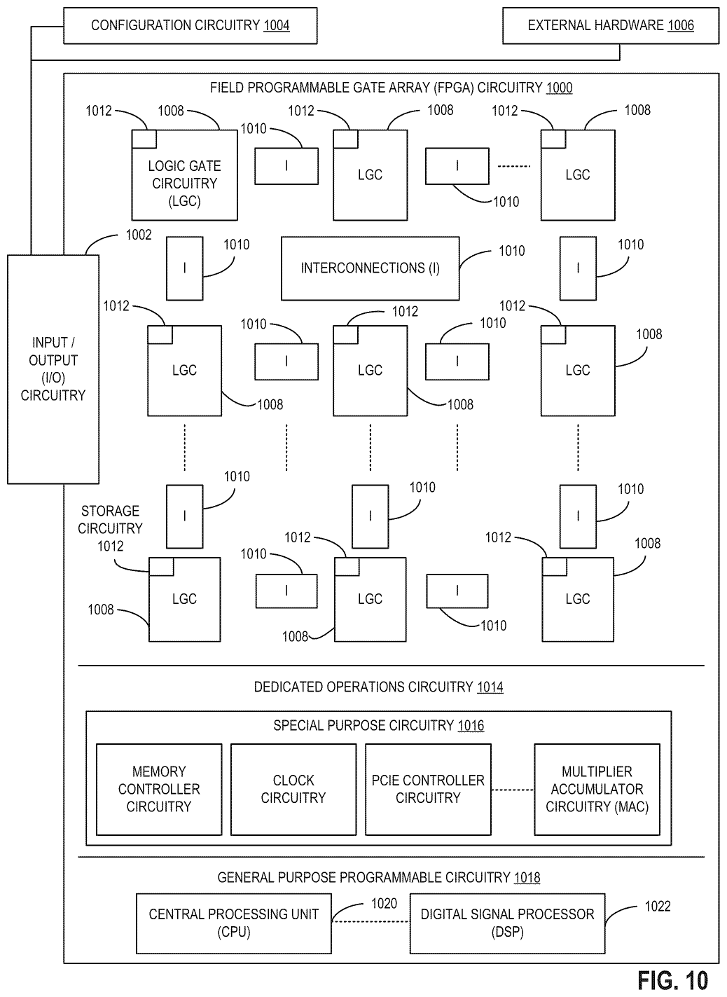

In some examples, the XAI system 100 includes means for interfacing. For example, the means for interfacing may be implemented by the interface circuitry 102. In some examples, the interface circuitry 102 may be instantiated by programmable circuitry such as the example programmable circuitry 812 of FIG. 8. For instance, the interface circuitry 102 may be instantiated by the example microprocessor 900 of FIG. 9 executing machine executable instructions such as those implemented by at least blocks 702 and 728 of FIG. 7. In some examples, the interface circuitry 102 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the interface circuitry 102 may be instantiated by any other combination of hardware, software, and/or firmware. For example, the interface circuitry 102 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 1, the adaptive sampling circuitry 104 is coupled to the interface circuitry 102, the model execution circuitry 106, and the saliency computation circuitry 108. The example adaptive sampling circuitry 104 of FIG. 1 generates one or more bitmasks (M) based on a kernel having one or more sizes. In the example of FIG. 1, a bitmask is modeled as a single kernel of a certain type and size where the kernel is placed at a certain position corresponding to an input image.

In the illustrated example of FIG. 1, the adaptive sampling circuitry 104 generates a variety of bitmasks having different kernel sizes. For example, the adaptive sampling circuitry 104 generates N bitmasks for K different kernel sizes (e.g., N*K total bitmasks). Because the scale (e.g., small, large, etc.) of an object in an input image is not known ahead of time (e.g., before the input image is processed by a machine learning model) and/or how a machine learning model will utilize features at different scales, the adaptive sampling circuitry 104 simultaneously perturbs an input image with bitmasks including kernels of different sizes. Subsequently, as described below, the saliency computation circuitry 108 aggregates saliency maps generated for bitmasks having different kernel sizes.

In the illustrated example of FIG. 1, a bitmask is a matrix having dimensions equivalent to those of an input image. The example bitmask includes a kernel centered at first coordinates of the matrix that match second coordinates of a pixel of an input image. In the example of FIG. 1, the kernel is a Gaussian kernel. For example, utilizing a Gaussian kernel can be beneficial for global optimization. In additional or alternative examples, different kernels may be used. For example, utilizing a rectangular kernel may improve properties of a saliency map landscape (e.g., to make the saliency map landscape less noisy and more parametric). To identify coordinates of a pixel at which a kernel of a bitmask is to be centered, the adaptive sampling circuitry 104 implements a global optimization function. For example, the adaptive sampling circuitry 104 implements a global optimization function that can sample representative regions of a saliency map in a gradient-free manner (e.g., without accessing gradients of a machine learning model).

In the illustrated example of FIG. 1, the global optimization function implemented by the adaptive sampling circuitry 104 attempts to find a single pixel (p*) that maximizes an objective function, S(p) (e.g., p*∈argmax S(p), p∈Ω), where a pixel (p) is represented by a position (e.g., two-dimensional (e.g., (x, y)) coordinates) of the pixel. As such, the global optimization function implemented by the adaptive sampling circuitry 104 optimizes pixel position to find a pixel position in an input image that maximizes the objective function. In examples disclosed herein, the objective function, S(p), of the global optimization function differs from the saliency map estimation function described below in connection with Equation 2. For example, in the global optimization function, the objective function, S(p), represents a saliency map computed for a masked input image where the bitmask is centered at pixel p having two-dimensional coordinates.

Conversely, the composite saliency map estimation function described in connection with Equation 2 is computed as a kernel density estimation (KDE) problem with gradient-free adaptive sampling of bitmasks as described below. As described below, in Equation 2, the composite saliency map estimation function implemented by the saliency computation circuitry 108 estimates the composite saliency map using KDE. To implemented KDE, the saliency computation circuitry 108 utilizes a representative set of saliency maps computed for masked input images utilizing a variety of bitmasks positioned at different areas (e.g., regions) of an input image.

In the illustrated example of FIG. 1, the global optimization function implemented by the adaptive sampling circuitry 104 is a global optimization of Lipschitz functions. As described above, the global optimization function implemented by the adaptive sampling circuitry 104 finds a pixel position in an input image that maximizes the objective function, S(p). The example objective function, S(p), ranges from zero to one (e.g., S(p)∈[0,1]). Thus, a saliency map computed for the global optimization function is similar to a grayscale image (e.g., the saliency map may be represented as a two-dimensional tensor) where each value (or pixel intensity) lies within the range of zero to one.

In example disclosed herein, the example global optimization of Lipschitz functions is a lightweight (e.g., less computationally intense as compared to other optimization functions) optimization function that is parameter-free (e.g., the global optimization of Lipschitz functions does not include hyperparameters). To implement the global optimization of Lipschitz functions, the adaptive sampling circuitry 104 approximates the objective function, S(p), with an upper bound function, U(p), such that U(p)>S(p) for p∈Ω. As such, the upper bound function, U(p), can be considered a candidate score corresponding to the objective function, S(p). Equation 1 illustrates the upper bound function, U(p).

U(p)=min(S(pᵢ)+l∥p−pᵢ∥²) Equation 1

An assumption of the example of Equation 1 is that evaluations of the objective function, S(p), for pixels p₁, p₂, . . . , pₜ are available. In the example of Equation 1, l is a Lipschitz constant for the objective function, S(p). In the example of Equation 1, the Lipschitz constant, l, can be estimated for every sample such that the Lipschitz constant, l, is equal to the largest slope between objective functions, S(p), for pixels that have already been evaluated.

When implementing the global optimization of Lipschitz functions, the adaptive sampling circuitry 104 (1) randomly selects a pixel, pⱼ, to evaluate and (2) determines whether the upper bound, U(pⱼ), is better than a current best value of the objective function, S(p). If the adaptive sampling circuitry 104 determines that the selected pixel generates an upper bound that is better than the current best value of the objective function, then the adaptive sampling circuitry 104 utilizes the coordinates of the selected pixel as the coordinates at which a kernel of a bitmask is to be centered. As such, the example adaptive sampling circuitry 104 of FIG. 1 ensures that the difference between the upper bound and the objective function is reduced (e.g., U(p)−S(p) is minimized).

In the illustrated example of FIG. 1, the adaptive sampling circuitry 104 fits a quadratic surface around the pixel providing the current best value of the objective function and optimizes the quadratic surface (e.g., up to a threshold precision). Accordingly, the adaptive sampling circuitry 104 improves local convergence. In the example of FIG. 1, the current best value of the objective function can be implemented as a current value of an objective function threshold. For example, when a candidate score for a pixel satisfies (e.g., exceeds) a current value of the objective function threshold, the adaptive sampling circuitry 104 sets a value of the objective function for the pixel to be the current value of the objective function threshold.

In additional or alternative examples, the adaptive sampling circuitry 104 may implement global optimization functions other than the global optimization of Lipschitz functions. For example, global optimization functions that are suitable for examples disclosed herein sample regions of low saliency with less frequency as compared to regions of high saliency. Additionally, for example, global optimization functions that are suitable for examples disclosed herein sample regions of high saliency more densely than regions of low saliency. Such global optimization functions (e.g., the global optimization of Lipschitz functions, among others) improves computational efficiency by utilizing more computing power to obtain fine-grained saliency maps of highly salient regions of an input image rather than other regions of the input image.

In examples disclosed herein, suitable global optimization functions balance local refinement and global exploration. As such, global optimization functions that are suitable for examples disclosed herein ensure that adaptive sampling will have enough samples within local optima regions while not being limited to the local optima regions. To operate on compute platforms having limited resources, global optimization functions that are suitable for examples disclosed herein should have reduced computational burden and reduced demand on memory. Additionally, to operate on compute platforms having limited resources, global optimization functions that are suitable for examples disclosed herein should not require significant tuning effort.

In the illustrated example of FIG. 1, after identifying the coordinates of a pixel at which a kernel of a bitmask is to be centered, the adaptive sampling circuitry 104 populates a matrix of the bitmask to generate the bitmask. For example, the adaptive sampling circuitry 104 utilizes a preserve paradigm to populate the matrix. In the preserve paradigm, the adaptive sampling circuitry 104 retains a region of the image within the kernel while regions of the image outside of the kernel are removed. The example preserve paradigm is advantageous as compared to remove and/or delete paradigms (e.g., where regions within a kernel are removed and regions outside of the kernel are retained). For example, when an image includes multiple objects of a target class for a classification task, utilizing the preserve paradigm is advantageous as compared to the remove and/or delete paradigm.

In the illustrated example of FIG. 1, to achieve the preserve paradigm, the adaptive sampling circuitry 104 sets first elements of the matrix that are within the kernel to be non-zero and second elements outside of the kernel to be zero. As described above, the kernel utilized in the example of FIG. 1 is a Gaussian kernel. As such, non-zero values within a kernel follow a two-dimensional Gaussian distribution centered at the pixel at which the kernel is centered. For example, non-zero values within a kernel range from zero to one (e.g., (0,1]) according to a two-dimension Gaussian distribution. The size of the kernel is defined based on the standard deviation (σ) of the Gaussian distribution. For example, as the standard deviation of the Gaussian distribution increases, the size (e.g., width) of the kernel also increases (e.g., the number of pixels retained in the masked input image increases).

In the illustrated example of FIG. 1, after generating a bitmask, the adaptive sampling circuitry 104 applies the bitmask (M) to an image (I) to generate a masked input image (x). To apply a bitmask (M) to an image (I), the adaptive sampling circuitry 104 computes the Hadamard product (⊗) between the input image (I) and the bitmask (M) (e.g., x=I⊗M). Although several pixels are retained after the adaptive sampling circuitry 104 applies a bitmask to an image in the preserve paradigm, the saliency score computed by the saliency computation circuitry 108 is assigned to the pixel at which the bitmask was applied to the image as described below. In some examples, the adaptive sampling circuitry 104 is instantiated by programmable circuitry executing adaptive sampling instructions and/or configured to perform operations such as those represented by the flowchart(s) of FIG. 7.

In some examples, the XAI system 100 includes means for sampling. For example, the means for sampling may be implemented by the adaptive sampling circuitry 104. In some examples, the adaptive sampling circuitry 104 may be instantiated by programmable circuitry such as the example programmable circuitry 812 of FIG. 8. For instance, the adaptive sampling circuitry 104 may be instantiated by the example microprocessor 900 of FIG. 9 executing machine executable instructions such as those implemented by at least blocks 704, 706, 714, 716, 722, and 724 of FIG. 7. In some examples, the adaptive sampling circuitry 104 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the adaptive sampling circuitry 104 may be instantiated by any other combination of hardware, software, and/or firmware. For example, the adaptive sampling circuitry 104 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 1, the model execution circuitry 106 is coupled to the adaptive sampling circuitry 104 and the saliency computation circuitry 108. In the example of FIG. 1, the model execution circuitry 106 implements a machine learning model that is to process an input image to the XAI system 100. For example, the model execution circuitry 106 implements a deep neural network (DNN). In additional or alternative examples, the model execution circuitry 106 implements any type of model. For example, the model execution circuitry 106 can implement a model having any architecture and/or complied/optimized models.

In the illustrated example of FIG. 1, the model implemented by the model execution circuitry 106 can be a model developed for classification tasks, a model developed for object detection tasks, and/or a model developed for any other type of task. In the example of FIG. 1, the model execution circuitry 106 generates an output based on a masked input image generated by the adaptive sampling circuitry 104. In some examples, the model execution circuitry 106 is instantiated by programmable circuitry executing model execution instructions and/or configured to perform operations such as those represented by the flowchart(s) of FIG. 7.

In some examples, the XAI system 100 includes means for executing. For example, the means for executing may be implemented by the model execution circuitry 106. In some examples, the model execution circuitry 106 may be instantiated by programmable circuitry such as the example programmable circuitry 812 of FIG. 8. For instance, the model execution circuitry 106 may be instantiated by the example microprocessor 900 of FIG. 9 executing machine executable instructions such as those implemented by at least block 708 of FIG. 7. In some examples, the model execution circuitry 106 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the model execution circuitry 106 may be instantiated by any other combination of hardware, software, and/or firmware. For example, the model execution circuitry 106 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 1, the saliency computation circuitry 108 is coupled to the interface circuitry 102, the adaptive sampling circuitry 104, the model execution circuitry 106, and the saliency score datastore 110. In the example of FIG. 1, the saliency computation circuitry 108 computes a saliency score for a pixel at which a bitmask was applied to an input image. For example, the saliency score is a measure of pixel importance with respect to an output generated by the machine learning model implemented by the model execution circuitry 106.

In the illustrated example of FIG. 1, the saliency computation circuitry 108 computes a saliency score, s, based on a task to be achieved by the machine learning model. For example, if the task to be achieved by the machine learning model is a classification task, the saliency computation circuitry 108 computes a model confidence score, s_{c}, of the target class, c, after sigmoid activation. Additionally or alternatively, if the task to be achieved by the machine learning model is an object detection task, the saliency computation circuitry 108 iterates over all predicted object boxes of target class, c, and take the maximum of s_{L}*s_{c}, where (1) s_{L} is a measure of the intersection between a target object box and a predicted object box and (2) s_{c} is the predicted object box confidence score (e.g., which may incorporate an objectiveness score).

In the illustrated example of FIG. 1, the saliency computation circuitry 108 records (e.g., causes storage of) the saliency score in the saliency score datastore 110. Additionally or alternatively, the saliency computation circuitry 108 forwards (e.g., causes transmission of) the saliency score to the adaptive sampling circuitry 104. As such, the adaptive sampling circuitry 104 can generate a subsequent bitmask based on the saliency score computed for the pixel at which the previous bitmask was applied to the input image.

As described above, the adaptive sampling circuitry 104 simultaneously perturbs an input image with bitmasks including kernels of different sizes to capture objects of different scales in an input image and/or provide a machine learning model with features at different scales. In the example of FIG. 1, the saliency computation circuitry 108 computes a saliency map for each kernel size utilized to perturb an input image. For example, a saliency map is based on saliency scores computed for bitmasks generated at the same kernel size.

In the illustrated example of FIG. 1, salient features can take any spatial location within an input image. Additionally, different features have different saliency and the distribution of saliency over features might take an arbitrary form. Accordingly, the saliency computation circuitry 108 models the location of salient features as a continuous random variable. As such, the saliency map can be formulated as a nonparametric probability distribution of saliency.

By considering a saliency map as a probability distribution of important features, the saliency computation circuitry 108 can apply probability density estimation, given constraints of a finite number of samples (e.g., due to computationally expensive processing with a machine learning model), a nonparametric function, and lack of access to gradients of a machine learning model. Thus, the saliency computation circuitry 108 can generate a saliency map as a kernel density estimation (KDE). For example, the saliency computation circuitry 108 generates a saliency map for a kernel size according to Equation 2 below.

S=Σⱼ₌₁^{K}norm(Σᵢ₌₁^{N}sᵢKⱼ(p−pᵢ)) Equation 2

In the example of Equation 2, N represents a number of samples (e.g., number of bitmasks generated at a kernel size) generated by the adaptive sampling circuitry 104 for pixels p₁, p₂, . . . , p_{N}. Additionally, in the example of Equation 2, K represents a number of different kernel widths utilized by the adaptive sampling circuitry 104 to generate bitmasks. In the example of FIG. 1, the saliency computation circuitry 108 is aware of kernel type and kernel parameters (e.g., kernel width) (e.g., kernel type and kernel parameters are hyperparameters of the adaptive sampling circuitry 104). In the example of Equation 2, saliency scores s₁, s₂, . . . , s_{N} are utilized to weight pixel values, p. By evaluating Equation 2, the saliency computation circuitry 108 estimates a probability density function (e.g., a saliency map) for an input image. In some examples, the saliency computation circuitry 108 is instantiated by programmable circuitry executing saliency computing instructions and/or configured to perform operations such as those represented by the flowchart(s) of FIG. 7.

In some examples, the XAI system 100 includes means for computing. For example, the means for computing may be implemented by the saliency computation circuitry 108. In some examples, the saliency computation circuitry 108 may be instantiated by programmable circuitry such as the example programmable circuitry 812 of FIG. 8. For instance, the saliency computation circuitry 108 may be instantiated by the example microprocessor 900 of FIG. 9 executing machine executable instructions such as those implemented by at least blocks 710, 712, 718, 720, and 726 of FIG. 7. In some examples, the saliency computation circuitry 108 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the saliency computation circuitry 108 may be instantiated by any other combination of hardware, software, and/or firmware. For example, the saliency computation circuitry 108 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 1, the saliency score datastore 110 is coupled to the saliency computation circuitry 108. In the example of FIG. 1, the XAI system 100 includes the saliency score datastore 110 to record data (e.g., one or more saliency scores, one or more saliency maps, one or more hyperparameters, one or more machine learning models, etc.). The saliency score datastore 110 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The saliency score datastore 110 may additionally or alternatively be implemented by one or more double data rate (DDR) memories, such as DDR, DDR2, DDR3, DDR4, DDR5, mobile DDR (mDDR), DDR SDRAM, etc. The saliency score datastore 110 may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the saliency score datastore 110 is illustrated as a single database, the saliency score datastore 110 may be implemented by any number and/or type(s) of databases. Furthermore, the data stored in the saliency score datastore 110 may be in any data format such as, for example, binary data, comma delimited data, tab delimited data, structured query language (SQL) structures, etc.

In example operation, the XAI system 100 utilizes global optimization to identify a pixel of an input image that maximizes an objective function. For example, Pseudocode 1 illustrates example pseudocode to estimate a saliency map for an image with the XAI system 100 of FIG. 1.

| Input: | input I, black-box model f, saliency score function h, number of |
|---|---|
| | kernels K (parameterized with kernel width σ), number of |
| | samples per kernel N |
| Output: | Saliency map S |
| 1. | S ← 0 |
| 2. | for kernel k = 1, . . . , K do |
| 3. | g ← initialized adaptive sampling circuitry |
| 4. | H ← { } |
| 5. | for sample n = 1, . . . , N do |
| 6. | M ← g.sample_mask( ) |
| 7. | x ← I ⊗ M |
| 8. | s← h(f(x)) |
| 9. | H ← H ∪ (M, s) |
| 10. | g.sample_mask(M, s) |
| 11. | end for |
| 12. | Sₖ ← normalize(KDE(H)) |
| 13. | S ← S + Sₖ |
| 14. | end for |

### Pseudocode 1

In the example of Pseudocode 1, at line 1, the saliency computation circuitry 108 initializes a composite saliency map variable, S. At line 2 of Pseudocode 1, the XAI system 100 enters a first for loop to iterate through K kernels having different widths (σ). At line 3 of the Pseudocode 1, the adaptive sampling circuitry 104 initializes. In the example Pseudocode 1, at line 4, the saliency computation circuitry 108 initializes a score matrix, H, for the current kernel width.

In the illustrated example of Pseudocode 1, at line 5, the XAI system 100 enters a second for loop to generate N bitmasks having the current kernel width. At line 6 of Pseudocode 1, the adaptive sampling circuitry 104 generates a bitmask according to a global optimization function. In the example of Pseudocode 1, at line 7, the adaptive sampling circuitry 104 perturbs the input image with the bitmask to generate a masked input image. For example, at line 7, the adaptive sampling circuitry 104 generates a first masked input image 116_{A} (e.g., perturbation i) based on a first bitmask having a kernel having a first width (e.g., kernel of size j) and centered at first coordinates of the input image.

In the illustrated example of Pseudocode 1, at line 8, the model execution circuitry 106 generates an output based on the masked input image. Additionally, at line 8, the saliency computation circuitry 108 computes a saliency score based on the output of the machine learning model implemented by the model execution circuitry 106. For example, the saliency computation circuitry 108 computes a salience score according to the saliency score function, h. At line 9 of Pseudocode 1, the saliency computation circuitry 108 adds the saliency score to the score matrix, H, and associates the saliency score with the current bitmask. For example, the saliency computation circuitry 108 takes the union of the saliency score and the score matrix, H. At line 10 of Pseudocode 1, the adaptive sampling circuitry 104 updates the global optimization function based on the current bitmask.

In the illustrated example of Pseudocode 1, at line 11, the XAI system 100 loops back to line 5 and repeats the operations of the second for loop (e.g., lines 6-10) until the adaptive sampling circuitry 104 has generated N bitmasks at the current kernel width. For example, on a second iteration, the adaptive sampling circuitry 104 generates a second masked input image 116_{B} (e.g., perturbation i+1) based on a second bitmask having a kernel having the first width (e.g., kernel of size j) and centered at second coordinates of the input image. At line 12 of Pseudocode 1, the saliency computation circuitry 108 computes a saliency map for the current kernel width. For example, at line 12 of Pseudocode 1, the saliency computation circuitry 108 executes Equation 2.

In the illustrated example of Pseudocode 1, at line 13, the saliency computation circuitry 108 aggregates the saliency map for the current kernel width with saliency maps generated for other kernel widths to aggregate a composite saliency map for the input image. In the example of Pseudocode 1, at line 14, the XAI system 100 loops back to line 2 and repeats the operations of the first for loop (e.g., lines 3-13) until the adaptive sampling circuitry 104 has generated N bitmasks for all kernel widths (e.g., 1, . . . , K). For example, on a second iteration of the first for loop, at line 7, the adaptive sampling circuitry 104 generates a third masked input image 118_{A} (e.g., perturbation i) based on a third bitmask having a kernel having a second width (e.g., kernel of size j+1) and centered at third coordinates of the input image. Additionally, on a second iteration of the first for loop and a second iteration of the second for loop, at line 7, the adaptive sampling circuitry 104 generates a fourth masked input image 118_{B} (e.g., perturbation i+1) based on a fourth bitmask having a kernel having the second width (e.g., kernel of size j+1) and centered at fourth coordinates of the input image.

As illustrated in the example of FIG. 1, the XAI system 100 perturbs one region of an input image at a time such that the saliency computation circuitry 108 can evaluate the output of a machine learning model processing the perturbed input image. Accordingly, the XAI system 100 utilizes the output of a machine learning model to determine pixel importance, S(p). As such, the XAI system 100 generates pixel importance scores that are not conditioned on the appearance of other regions of an image. As such, the XAI system 100 provides a clear relation between one region of an image and one saliency score which improves the utility of saliency maps to explain an AI system.

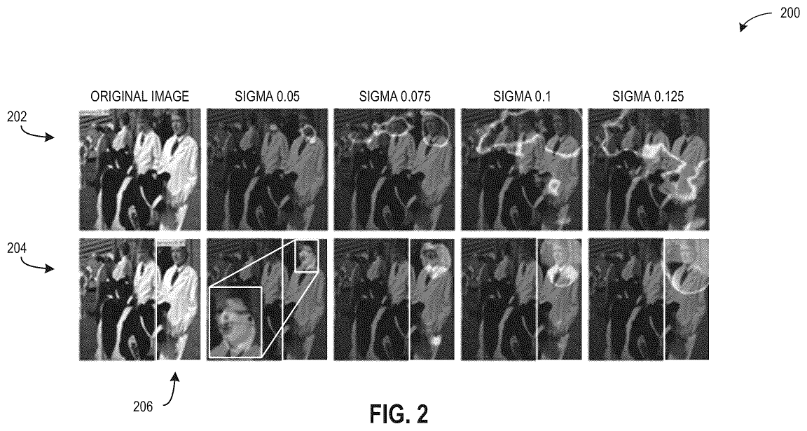

FIG. 2 is a graphical illustration 200 depicting example saliency maps generated by the XAI system 100 of FIG. 1. For example, the graphical illustration 200 depicts first example saliency maps 202 generated for a machine learning model performing a classification task and second example saliency maps 204 generated for a machine learning model performing an object detection task for an object within an example bounded box 206. The first saliency maps 202 and the second saliency maps 204 illustrate bitmasks generated with different kernel widths (e.g., σ=[0.05, 0.075, 0.1, 0.125]).

In the illustrated example of FIG. 2, the kernels are Gaussian kernels. In the example of FIG. 2, the first saliency maps 202 were generated for a ResNet-50 model. Additionally, the second saliency maps 204 were generated for a You Only Look Once X (YOLOX) model. As illustrated in FIG. 2, a saliency map is a function of kernel width. Additionally, saliency maps can take an arbitrary form with many local optima.

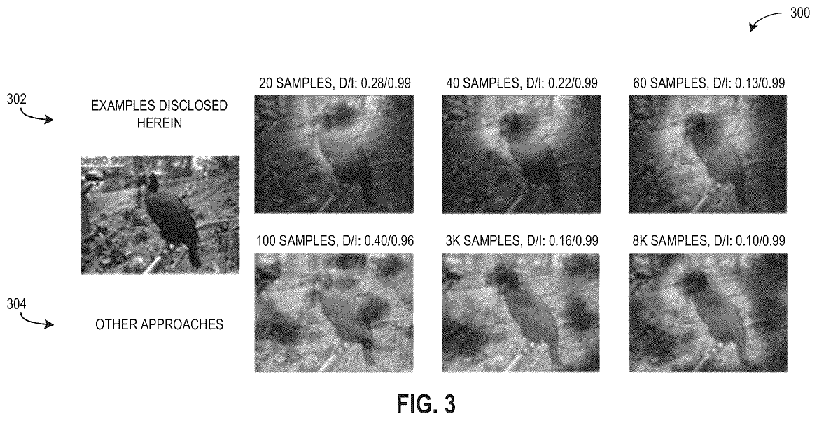

FIG. 3 is a graphical illustration 300 depicting additional example saliency maps generated by the XAI system 100 of FIG. 1. For example, the graphical illustration 300 includes first example saliency maps 302 generated by the XAI system 100 of FIG. 1 and second example saliency maps 304 generated according to other approaches. In the example of FIG. 3, the first saliency maps 302 and the second saliency maps 304 illustrate convergence speed for deletion (D) and insertion (I) metrics.

For example, a deletion metric refers to a measurement of the drop in probability of a class as salient pixels are removed from an image where saliency is determined by the saliency map. A lower deletion metric indicates that an XAI system is better at explaining an AI model. An insertion metric measures the importance of pixels in terms of the ability of the pixels to synthesize an image. An insertion metric is measured by the rise in probability of a class of interest as pixels are added according to the saliency map. A higher insertion metric indicates that an XAI system is better at explaining an AI model.

In the illustrated example of FIG. 3, the deletion and insertion metrics are computed based on saliency maps generated with different numbers of samples. For example, the first saliency maps 302 are generated with 20 samples, 40 samples, and 60 samples. Additionally, for example, the second saliency maps 304 are generated with 100 samples, 3,000 samples, and 8,000 samples.

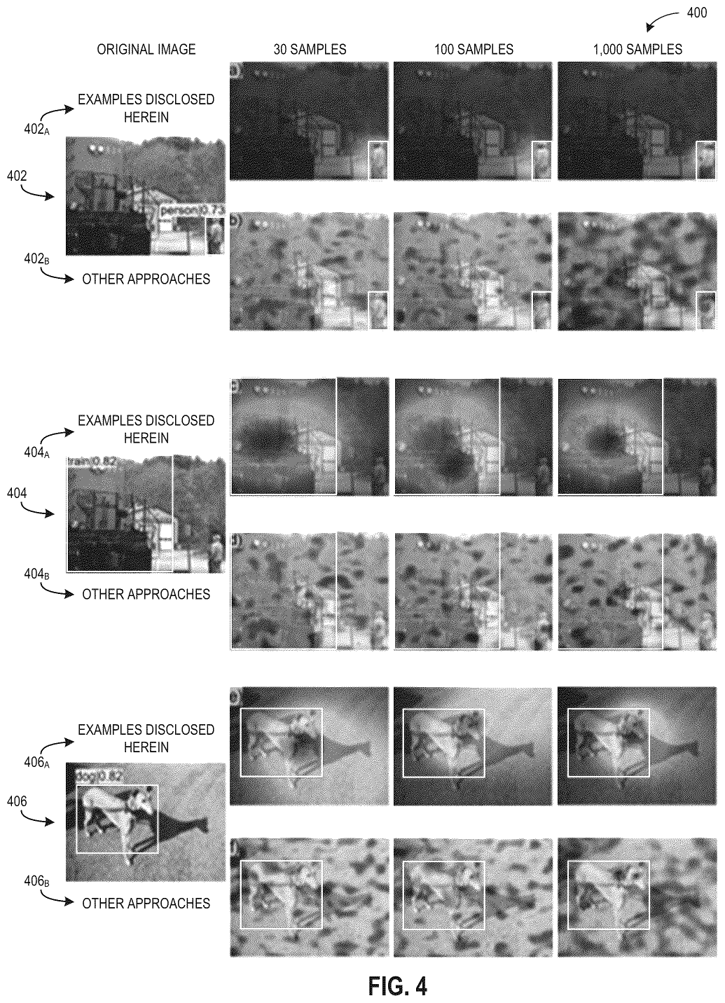

FIG. 4 is a graphical illustration 400 depicting further example saliency maps generated for detection of different objects in images. The illustrated example of FIG. 4 depicts a qualitative comparison between examples disclosed herein and other approaches for an object detection task. For example, the graphical illustration 400 includes example first saliency maps 402 generated for detection of a person, example second saliency maps 404 generated for detection of a train, and example third saliency maps 406 generated for detection of a dog.

In the illustrated example of FIG. 4, the first saliency maps 402 include saliency maps 402_{A} generated by the XAI system 100 and saliency maps 402_{B} generated according to other approaches. Additionally, the second saliency maps 404 include saliency maps 404_{A} generated by the XAI system 100 and saliency maps 404_{B} generated according to other approaches. Furthermore, the third saliency maps 406 include saliency maps 406_{A} generated by the XAI system 100 and saliency maps 406_{B} generated according to other approaches.

In the illustrated example of FIG. 4, the first saliency maps 402, the second saliency maps 404, and the third saliency maps 406 are generated with varying numbers of samples (e.g., bitmasks). For example, the first saliency maps 402, the second saliency maps 404, and the third saliency maps 406 are generated with 30 samples, 100 samples, and 1,000 samples. As described above, FIG. 4 illustrates a qualitative comparison between examples disclosed herein and other approaches. As depicted in FIG. 4, the XAI system 100 generates effective saliency maps after 30 samples, while other approaches require at least 100 samples to generate a usable saliency map and may require as many as 1,000 samples.

In the illustrated example of FIG. 4, other approaches consistently perform poorly for large scale objects whereas the XAI system 100 effectively generates saliency maps for large scale objects. For example, even after 1,000 samples, the saliency maps 404_{B} generated according to other approaches do not effectively identify which pixels of the input image led to detection of a train in the input image. However, after 30 samples, the saliency maps 404_{A} generated by the XAI system 100 effectively identify which pixels of the input image led to detection of a train in the input image and the saliency maps 404_{A} are further refined as more samples are generated by the adaptive sampling circuitry 104. As described above, by applying kernels with different widths, the XAI system 100 effectively detects objects of different sizes.

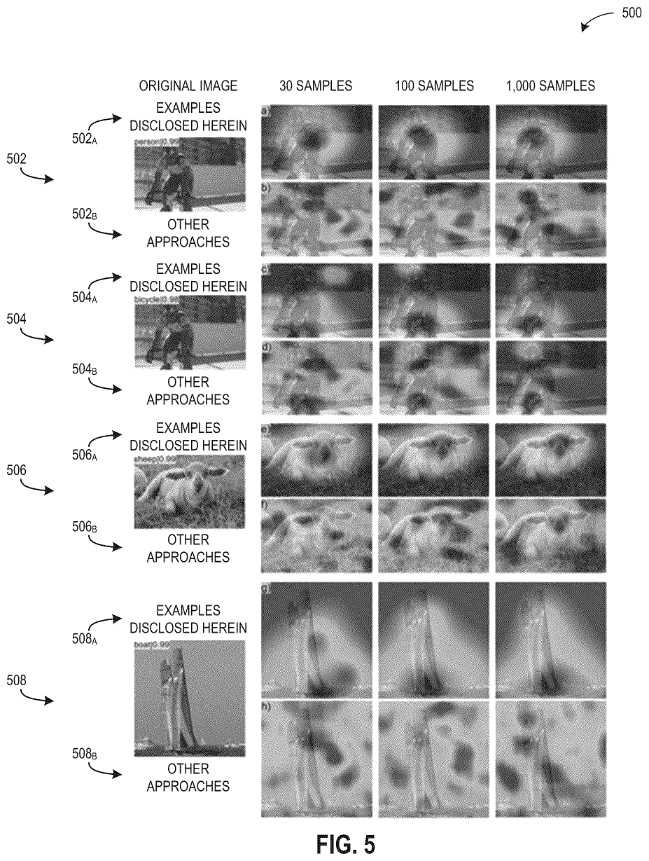

FIG. 5 is a graphical illustration 500 depicting yet other example saliency maps generated for classification of different images. The illustrated example of FIG. 5 depicts a qualitative comparison between examples disclosed herein and other approaches for a classification task. For example, the graphical illustration 500 includes example first saliency maps 502 generated for classification of a person, example second saliency maps 504 generated for classification of a bicycle, example third saliency maps 506 generated for classification of a sheep, and example fourth saliency maps 508 generated for classification of a boat.

In the illustrated example of FIG. 5, the first saliency maps 502 include saliency maps 502_{A} generated by the XAI system 100 and saliency maps 502_{B} generated according to other approaches. Additionally, the second saliency maps 504 include saliency maps 504_{A} generated by the XAI system 100 and saliency maps 504_{B} generated according to other approaches. The third saliency maps 506 include saliency maps 506_{A} generated by the XAI system 100 and saliency maps 506_{B} generated according to other approaches. Furthermore, the fourth saliency maps 508 include saliency maps 508_{A} generated by the XAI system 100 and saliency maps 508_{B} generated according to other approaches.

In the illustrated example of FIG. 5, the first saliency maps 502, the second saliency maps 504, the third saliency maps 506, and the fourth saliency maps 508 are generated with varying numbers of samples (e.g., bitmasks). For example, the first saliency maps 502, the second saliency maps 504, the third saliency maps 506, and the fourth saliency maps 508 are generated with 30 samples, 100 samples, and 1,000 samples. As described above, FIG. 5 illustrates a qualitative comparison between examples disclosed herein and other approaches. As depicted in FIG. 5, the XAI system 100 generates effective saliency maps after 30 samples, while other approaches require at least 100 samples to generate a usable saliency map and may require as many as 1,000 samples.

In the illustrated example of FIG. 5, other approaches consistently perform poorly for large scale objects whereas the XAI system 100 effectively generates saliency maps for large scale objects. For example, even after 1,000 samples, the saliency maps 508_{B} generated according to other approaches do not effectively identify which pixels of the input image led to classification of the input image as a boat. However, after 100 samples, the saliency maps 508_{A} generated by the XAI system 100 effectively identify which pixels of the input image led to classification of the input image as a boat and the saliency maps 508_{A} are further refined as more samples are generated by the adaptive sampling circuitry 104. As described above, by applying kernels with different widths, the XAI system 100 effectively detects objects of different sizes.

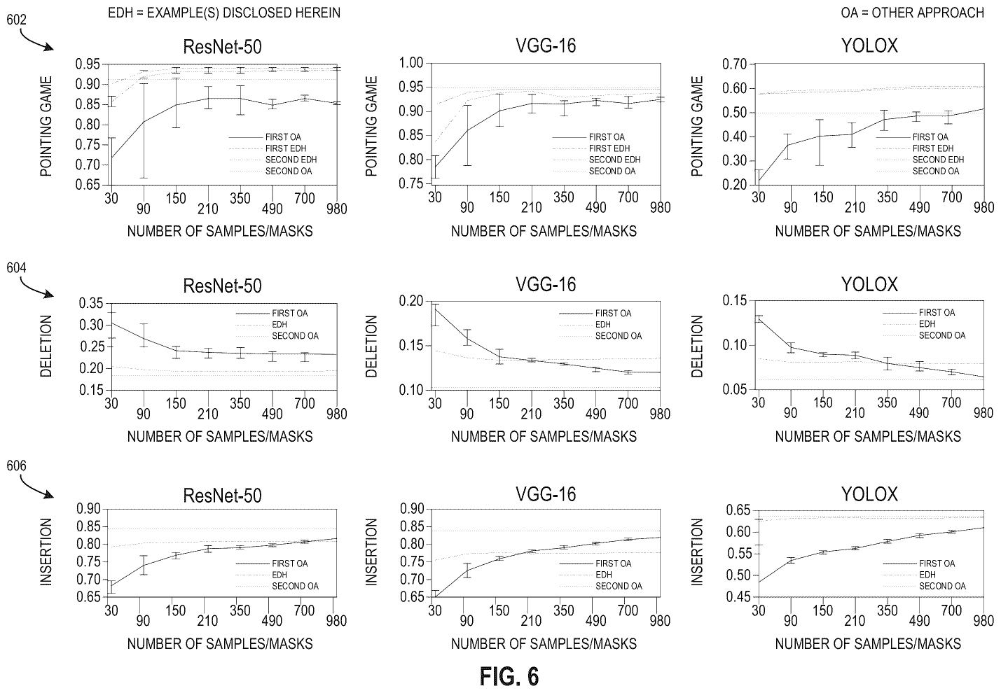

FIG. 6 is a graphical illustration 600 depicting example performance of the XAI system 100 of FIG. 1. For example, FIG. 6 illustrates the performance of the XAI system 100 compared to other approaches. In the example of FIG. 6, the graphical illustration 600 includes example first graphs 602 depicting pointing game metrics of the XAI system 100 and other approaches in evaluating a variety of models. Additionally, the graphical illustration 600 includes example second graphs 604 depicting deletion metrics of the XAI system 100 and other approaches in evaluating a variety of models. The graphical illustration 600 also includes example third graphs 606 depicting insertion metrics of the XAI system 100 and other approaches in evaluating a variety of model architectures. For example, FIG. 6 illustrates the ability of the XAI system 100 and other approaches to explain the ResNet-50 model, the Visual Geometry Group 16 (VGG-16) model, and the YOLOX model.

As described above, a deletion metric refers to a measurement of the drop in probability of a class as salient pixels are removed from an image where a lower deletion metric indicates that an XAI system is better at explaining an AI model. Additionally, an insertion metric is measured by the rise in probability of a class of interest as pixels are added according to the saliency map where a higher insertion metric indicates that an XAI system is better at explaining an AI model. A pointing game metric refers to a measurement of how accurate a model is at detecting an object in an image. The pointing game metric is a measure of model accuracy that is determined as a ratio between the number of accurate model predictions over the total model predictions. A higher accuracy indicates that an XAI system is better at explaining an AI model.

In the illustrated example of FIG. 6, metrics are computed using a pattern analysis, statistical modeling and computational learning (PASCAL) visual object classes (VOC) test set. For insertion and deletion metrics, 224 pixels were inserted or deleted per iteration for classification and 416 pixels were inserted or deleted for detection. As illustrated in FIG. 6, the XAI system 100 converges much faster in general. For example, within 100-200 iterations the XAI system 100 achieves better performance than other approaches for the pointing game metric. Additionally, within 100-200 iterations the XAI system 100 achieves better performance than other approaches for the deletion metric with the ResNet-50 model architecture. Furthermore, within 100-200 iterations the XAI system 100 achieves better performance than other approaches for the insertion metric with the YOLOX model architecture.

As illustrated in FIG. 6, the XAI system 100 is capable of achieving convergence more than ten times faster in some cases than other approaches. For example, referring to FIG. 3, the XAI system 100 achieves more than 50 times gain in convergence speed. While other approaches may achieve better performance than the XAI system 100, this generally only occurs after hundreds of samples which makes the other approaches impractical for resource constrained compute platforms.

In the illustrated example of FIG. 6, the XAI system 100 achieves reduced deviation from a mean metric value as compared to other approaches. For example, when utilizing the global optimization of Lipschitz functions as a global optimization function, the XAI system 100 consistently achieves the mean metric value in less than 1,000. Similar performance is achieved when implementing different global optimization functions for the XAI system 100.

While an example manner of implementing the XAI system 100 of FIG. 1 is illustrated in FIG. 1, one or more of the elements, processes, and/or devices illustrated in FIG. 1 may be combined, divided, re-arranged, omitted, eliminated, and/or implemented in any other way. Further, the example interface circuitry 102, the example adaptive sampling circuitry 104, the example model execution circuitry 106, the example saliency computation circuitry 108, the saliency score datastore 110, and/or, more generally, the example XAI system 100 of FIG. 1, may be implemented by hardware alone or by hardware in combination with software and/or firmware. Thus, for example, any of the example interface circuitry 102, the example adaptive sampling circuitry 104, the example model execution circuitry 106, the example saliency computation circuitry 108, the saliency score datastore 110, and/or, more generally, the example XAI system 100, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example XAI system 100 of FIG. 1 may include one or more elements, processes, and/or devices in addition to, or instead of, those illustrated in FIG. 1, and/or may include more than one of any or all of the illustrated elements, processes, and devices.

A flowchart representative of example machine readable instructions, which may be executed by programmable circuitry (e.g., instructions to cause programmable circuitry) to implement and/or instantiate the XAI system 100 of FIG. 1 and/or representative of example operations which may be performed by programmable circuitry to implement and/or instantiate the XAI system 100 of FIG. 1, are shown in FIG. 7. The machine readable instructions may be one or more executable programs or portion(s) of one or more executable programs for execution by programmable circuitry such as the programmable circuitry 812 shown in the example programmable circuitry platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 7, many other methods of implementing the example XAI system 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations 700 that may be executed, instantiated, and/or performed by example programmable circuitry to implement the XAI system 100 of FIG. 1. In the example of FIG. 7, the XAI system 100 generates a saliency map incorporating pixels within an input image. As described above, the saliency map indicates a measure of pixel importance, s, in the range of zero to one (e.g., s∈[0,1]). When a pixel is strongly responsible for an output of a machine learning model, such as making a prediction by the machine learning model when processing the input image, the saliency score for the pixel may be one whereas when a pixel does not correlate with an output of a model, the saliency score for the pixel may be zero.

In the illustrated example of FIG. 7, the example machine-readable instructions and/or the example operations 700 of FIG. 7 begin at block 702, at which the interface circuitry 102 accesses an input image. For example, the input image may have dimension [0, . . . , H−1]×[0, . . . , W−1]. At block 704, the adaptive sampling circuitry 104 generates a first bitmask based on a current kernel size. For example, the adaptive sampling circuitry 104 populates a matrix to generate the first bitmask, where the matrix includes a kernel centered at first coordinates of the matrix that match second coordinates of a pixel of the input image. As described above, the adaptive sampling circuitry 104 sets first values within the kernel to be non-zero (e.g., first values within the kernel being non-zero) and second values outside of the kernel to be zero (e.g., second values outside of the kernel being zero).

In the illustrated example of FIG. 7, at block 706, the adaptive sampling circuitry 104 applies the current bitmask to the input image at a pixel of the input image to generate a masked input image. For example, the adaptive sampling circuitry 104 computes the Hadamard product between the input image and the current bitmask. At block 708, the model execution circuitry 106 generates, with a machine learning model, an output based on the masked input image. At block 710, the saliency computation circuitry 108 computes a first saliency score for the pixel at which the current bitmask was applied to the input image. For example, the saliency score is based on a task to be achieved by the output generated by the machine learning model.

In the illustrated example of FIG. 7, at block 712, the saliency computation circuitry 108 records the first saliency score for the pixel in the saliency score datastore 110. At block 714, the adaptive sampling circuitry 104 determines whether there is an additional bitmask to be generated at the current kernel size. Based on (e.g., in response to) the adaptive sampling circuitry 104 determining that there is an additional bitmask to be generated at the current kernel size (block 714: YES), the machine-readable instructions and/or the operations 700 proceed to block 716. Based on (e.g., in response to) the adaptive sampling circuitry 104 determining that there is not an additional bitmask to be generated at the current kernel size (block 714: NO), the machine-readable instructions and/or the operations 700 proceed to block 718.

In the illustrated example of FIG. 7, at block 716, the adaptive sampling circuitry 104 generates a second bitmask to be applied to the input image based on the first saliency score computed for the pixel at which the first bitmask was applied to the input image. At block 716, the adaptive sampling circuitry 104 generates the second bitmask based on the current kernel size. At block 718, the saliency computation circuitry 108 computes a saliency map for the current kernel size. For example, the saliency computation circuitry 108 implements Equation 2 as described above. As such, the saliency map is based on the saliency scores computed for bitmasks generated at the current kernel size. As described above, the saliency computation circuitry 108 generates the saliency map without accessing at least one of parameters of the machine learning model, features identified by the machine learning model, or gradients corresponding to the machine learning model.

In the illustrated example of FIG. 7, at block 720, the saliency computation circuitry 108 adds the saliency map to a composite saliency map for the input image. At block 722, the adaptive sampling circuitry 104 determines whether there is an additional kernel size. Based on (e.g., in response to) the adaptive sampling circuitry 104 determining that there is an additional kernel size (block 722: YES), the machine-readable instructions and/or the operations 700 proceed to block 724. Based on (e.g., in response to) the adaptive sampling circuitry 104 determining that there is not an additional kernel size (block 722: NO), the machine-readable instructions and/or the operations 700 proceed to block 728.

In the illustrated example of FIG. 7, at block 724, the adaptive sampling circuitry 104 initializes for the next kernel size. At block 726, the saliency computation circuitry 108 initializes the saliency score datastore 110 for the next kernel size. At block 728, the interface circuitry 102 outputs the composite saliency map for the input image. The example process of FIG. 7 then terminates but may be executed again upon receipt of a subsequent image.

FIG. 8 is a block diagram of an example programmable circuitry platform 800 structured to execute and/or instantiate the example machine-readable instructions and/or the example operations of FIG. 7 to implement the XAI system 100 of FIG. 1. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example interface circuitry 102, the example adaptive sampling circuitry 104, the example model execution circuitry 106, and the example saliency computation circuitry 108.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In this example, the one or more mass storage discs or devices 828 implement the saliency score datastore 110.

The machine readable instructions 832, which may be implemented by the machine readable instructions of FIG. 7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowchart of FIG. 7 to effectively instantiate the circuitry of FIG. 1 as logic circuits to perform operations corresponding to those machine readable instructions. In some such examples, the circuitry of FIG. 1 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowchart of FIG. 7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart of FIG. 7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart of FIG. 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 7. As such, the FPGA circuitry 1000 may be configured and/or structured to effectively instantiate some or all of the operations/functions corresponding to the machine readable instructions of the flowchart of FIG. 7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIG. 7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIG. 7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 10. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart of FIG. 7 to perform first operation(s)/function(s), the FPGA circuitry 1000 of FIG. 10 may be configured and/or structured to perform second operation(s)/function(s) corresponding to a second portion of the machine readable instructions represented by the flowchart of FIG. 7, and/or an ASIC may be configured and/or structured to perform third operation(s)/function(s) corresponding to a third portion of the machine readable instructions represented by the flowchart of FIG. 7.

It should be understood that some or all of the circuitry of FIG. 1 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 1 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

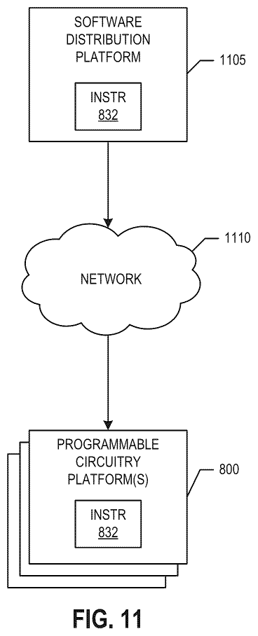

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIG. 7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIG. 7, may be downloaded to the example programmable circuitry platform 800, which is to execute the machine readable instructions 832 to implement the XAI system 100. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that provide fast and efficient black-box model explanation method that can be applied to any kind of model architectures and/or algorithm design. Disclosed methods, apparatus, and articles of manufacture provide model explanation results with 10-50× less computational burden compared to other approaches which improves the adoptability of XAI systems. Additionally, examples disclosed herein can efficiently and effectively explain optimized models for deployment. Disclosed systems, apparatus, articles of manufacture, and methods improve the efficiency of using a computing device by providing a general framework for designing a black-box XAI system that is not bound by a specific choice of kernel and/or global optimization function. As such, examples disclosed herein can be used as a fundamental framework for future development of XAI algorithms. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to explain machine learning models are disclosed herein. Further examples and combinations thereof include the following:

Example 1 includes an apparatus comprising interface circuitry to access an input image including one or more pixels, computer executable instructions, and programmable circuitry to utilize the computer executable instructions to generate a bitmask having a kernel size, apply the bitmask to the input image to generate a first masked input image, compute a first saliency score for a first pixel of the input image based on the first masked input image, compute a second saliency score for a second pixel of the input image based on an output generated by a machine learning model, the output based on a second masked input image, and generate a saliency map for the input image based on the first saliency score and the second saliency score, the saliency map indicative of at least one feature of the input image that contributed to training of the machine learning model.

Example 2 includes the apparatus of example 1, wherein the bitmask is a first bitmask, and the programmable circuitry is to generate a second bitmask having the kernel size, the second bitmask based on the first saliency score computed for the first pixel of the input image at which the first bitmask was applied to the input image.

Example 3 includes the apparatus of any of examples 1 or 2, wherein the input image has first dimensions, the bitmask is a matrix having second dimensions equivalent to the first dimensions, and the programmable circuitry is to compute a candidate score for the first pixel, the candidate score corresponding to an objective function for the first pixel, and when the candidate score satisfies a current value of an objective function threshold, populate the matrix to generate the bitmask, the matrix including a kernel having the kernel size, the kernel centered at first coordinates of the matrix that match second coordinates of the first pixel, first values within the kernel being non-zero, second values outside of the kernel being zero.

Example 4 includes the apparatus of example 3, wherein the kernel is a Gaussian kernel.

Example 5 includes the apparatus of any of examples 1, 2, 3, or 4, wherein the input image has first dimensions, the bitmask is a matrix having second dimensions equivalent to the first dimensions, the matrix includes a kernel having the kernel size, the kernel centered at first coordinates of the matrix that match second coordinates of the first pixel, and the programmable circuitry is to compute a Hadamard product between the input image and the matrix to apply the bitmask to the input image.

Example 6 includes the apparatus of any of examples 1, 2, 3, 4, or 5, wherein the kernel size is a first kernel size, the saliency map is a first saliency map generated for first bitmasks having the first kernel size, and the programmable circuitry is to aggregate the first saliency map with a second saliency map to generate a composite saliency map for the input image, the second saliency map generated for second bitmasks having a second kernel size different than the first kernel size.

Example 7 includes the apparatus of any of examples 1, 2, 3, 4, 5, or 6, wherein the programmable circuitry is to compute the second saliency score based on a task to be achieved by the machine learning model.

Example 8 includes the apparatus of any of examples 1, 2, 3, 4, 5, 6, or 7, wherein the programmable circuitry is to generate the saliency map without accessing any of parameters of the machine learning model, features identified by the machine learning model, or gradients corresponding to the machine learning model.

Example 9 includes the apparatus of any of examples 1, 2, 3, 4, 5, 6, 7, or 8, wherein the at least one feature corresponds to at least one of the one or more pixels of the input image.

Example 10 includes a non-transitory machine readable storage medium comprising instructions to cause programmable circuitry to at least generate a bitmask having a kernel size, apply the bitmask to an input image to generate a first masked input image, the input image including one or more pixels, compute a first saliency score for a first pixel of the input image based on the first masked input image, compute a second saliency score for a second pixel of the input image based on an output generated by a machine learning model, the output based on a second masked input image, and generate a saliency map for the input image based on the first saliency score and the second saliency score, the saliency map indicative of at least one feature of the input image that contributed to training of the machine learning model.

Example 11 includes the non-transitory machine readable storage medium of example 10, wherein the bitmask is a first bitmask, and the instructions cause the programmable circuitry to generate a second bitmask having the kernel size, the second bitmask based on the first saliency score computed for the first pixel of the input image at which the first bitmask was applied to the input image.

Example 12 includes the non-transitory machine readable storage medium of any of examples 10 or 11, wherein the input image has first dimensions, the bitmask is a matrix having second dimensions equivalent to the first dimensions, and the instructions cause the programmable circuitry to compute a candidate score for the first pixel, the candidate score corresponding to an objective function for the first pixel, and when the candidate score satisfies a current value of an objective function threshold, populate the matrix to generate the bitmask, the matrix including a kernel having the kernel size, the kernel centered at first coordinates of the matrix that match second coordinates of the first pixel, first values within the kernel being non-zero, second values outside of the kernel being zero.

Example 13 includes the non-transitory machine readable storage medium of example 12, wherein the kernel is a Gaussian kernel.

Example 14 includes the non-transitory machine readable storage medium of any of examples 10, 11, 12, or 13, wherein the input image has first dimensions, the bitmask is a matrix having second dimensions equivalent to the first dimensions, the matrix includes a kernel having the kernel size, the kernel centered at first coordinates of the matrix that match second coordinates of the first pixel, and the instructions cause the programmable circuitry to compute a Hadamard product between the input image and the matrix to apply the bitmask to the input image.

Example 15 includes the non-transitory machine readable storage medium of any of examples 10, 11, 12, 13, or 14, wherein the kernel size is a first kernel size, the saliency map is a first saliency map generated for first bitmasks having the first kernel size, and the instructions cause the programmable circuitry to aggregate the first saliency map with a second saliency map to generate a composite saliency map for the input image, the second saliency map generated for second bitmasks having a second kernel size different than the first kernel size.

Example 16 includes the non-transitory machine readable storage medium of any of examples 10, 11, 12, 13, 14, or 15, wherein the instructions cause the programmable circuitry to compute the second saliency score based on a task to be achieved by the machine learning model.

Example 17 includes the non-transitory machine readable storage medium of any of examples 10, 11, 12, 13, 14, 15, or 16, wherein the instructions cause the programmable circuitry to generate the saliency map without accessing any of parameters of the machine learning model, features identified by the machine learning model, or gradients corresponding to the machine learning model.

Example 18 includes the non-transitory machine readable storage medium of any of examples 10, 11, 12, 13, 14, 15, 16, or 17, wherein the at least one feature corresponds to at least one of the one or more pixels of the input image.

Example 19 includes a method comprising generating, by utilizing an instruction with programmable circuitry, a bitmask having a kernel size, applying, by utilizing an instruction with the programmable circuitry, the bitmask to an input image to generate a first masked input image, the input image including one or more pixels, computing, by utilizing an instruction with the programmable circuitry, a first saliency score for a first pixel of the input image based on the first masked input image, computing, by utilizing an instruction with the programmable circuitry, a second saliency score for a second pixel of the input image based on an output generated by a machine learning model, the output based on a second masked input image, and generating, by utilizing an instruction with the programmable circuitry, a saliency map for the input image based on the first saliency score and the second saliency score, the saliency map indicative of at least one feature of the input image that contributed to training of the machine learning model.

Example 20 includes the method of example 19, wherein the bitmask is a first bitmask, and the method further includes generating a second bitmask having the kernel size, the second bitmask based on the first saliency score computed for the first pixel of the input image at which the first bitmask was applied to the input image.

Example 21 includes the method of any of examples 19 or 20, wherein the input image has first dimensions, the bitmask is a matrix having second dimensions equivalent to the first dimensions, and the method further includes computing a candidate score for the first pixel, the candidate score corresponding to an objective function for the first pixel, and when the candidate score satisfies a current value of an objective function threshold, populating the matrix to generate the bitmask, the matrix including a kernel having the kernel size, the kernel centered at first coordinates of the matrix that match second coordinates of the second pixel, first values within the kernel being non-zero, second values outside of the kernel being zero.

Example 22 includes the method of example 21, wherein the kernel is a Gaussian kernel.

Example 23 includes the method of any of examples 19, 20, 21, or 22, wherein the input image has first dimensions, the bitmask is a matrix having second dimensions equivalent to the first dimensions, the matrix includes a kernel having the kernel size, the kernel centered at first coordinates of the matrix that match second coordinates of the first pixel, and the method further includes computing a Hadamard product between the input image and the matrix to apply the bitmask to the input image.

Example 24 includes the method of any of examples 19, 20, 21, 22, or 23, wherein the kernel size is a first kernel size, the saliency map is a first saliency map generated for first bitmasks having the first kernel size, and the method further includes aggregating the first saliency map with a second saliency map to generate a composite saliency map for the input image, the second saliency map generated for second bitmasks having a second kernel size different than the first kernel size.

Example 25 includes the method of any of examples 19, 20, 21, 22, 23, or 24, further including computing the second saliency score based on a task to be achieved by the machine learning model.

Example 26 includes the method of any of examples 19, 20, 21, 22, 23, 24, or 25, further including generating the saliency map without accessing any of parameters of the machine learning model, features identified by the machine learning model, or gradients corresponding to the machine learning model.

Example 27 includes the method of any of examples 19, 20, 21, 22, 23, 24, 25, or 26, wherein the at least one feature corresponds to at least one of the one or more pixels of the input image.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry to access an input image including one or more pixels;
computer executable instructions; and
programmable circuitry to utilize the computer executable instructions to:
generate a bitmask having a kernel size;
apply the bitmask to the input image to generate a first masked input image;
compute a first saliency score for a first pixel of the input image based on the first masked input image;
compute a second saliency score for a second pixel of the input image based on an output generated by a machine learning model, the output based on a second masked input image; and
generate a saliency map for the input image based on the first saliency score and the second saliency score, the saliency map indicative of at least one feature of the input image that contributed to training of the machine learning model.

2. The apparatus of claim 1, wherein the bitmask is a first bitmask, and the programmable circuitry is to generate a second bitmask having the kernel size, the second bitmask based on the first saliency score computed for the first pixel of the input image at which the first bitmask was applied to the input image.

3. The apparatus of claim 1, wherein the input image has first dimensions, the bitmask is a matrix having second dimensions equivalent to the first dimensions, and the programmable circuitry is to:
compute a candidate score for the first pixel, the candidate score corresponding to an objective function for the first pixel; and
when the candidate score satisfies a current value of an objective function threshold, populate the matrix to generate the bitmask, the matrix including a kernel having the kernel size, the kernel centered at first coordinates of the matrix that match second coordinates of the first pixel, first values within the kernel being non-zero, second values outside of the kernel being zero.

4. The apparatus of claim 3, wherein the kernel is a Gaussian kernel.

5. The apparatus of claim 1, wherein the input image has first dimensions, the bitmask is a matrix having second dimensions equivalent to the first dimensions, the matrix includes a kernel having the kernel size, the kernel centered at first coordinates of the matrix that match second coordinates of the first pixel, and the programmable circuitry is to compute a Hadamard product between the input image and the matrix to apply the bitmask to the input image.

6. The apparatus of claim 1, wherein the kernel size is a first kernel size, the saliency map is a first saliency map generated for first bitmasks having the first kernel size, and the programmable circuitry is to aggregate the first saliency map with a second saliency map to generate a composite saliency map for the input image, the second saliency map generated for second bitmasks having a second kernel size different than the first kernel size.

7. The apparatus of claim 1, wherein the programmable circuitry is to compute the second saliency score based on a task to be achieved by the machine learning model.

8. The apparatus of claim 1, wherein the programmable circuitry is to generate the saliency map without accessing any of parameters of the machine learning model, features identified by the machine learning model, or gradients corresponding to the machine learning model.

9. The apparatus of claim 1, wherein the at least one feature corresponds to at least one of the one or more pixels of the input image.

10. A non-transitory machine readable storage medium comprising instructions to cause programmable circuitry to at least:
generate a bitmask having a kernel size;
apply the bitmask to an input image to generate a first masked input image, the input image including one or more pixels;
compute a first saliency score for a first pixel of the input image based on the first masked input image;
compute a second saliency score for a second pixel of the input image based on an output generated by a machine learning model, the output based on a second masked input image; and
generate a saliency map for the input image based on the first saliency score and the second saliency score, the saliency map indicative of at least one feature of the input image that contributed to training of the machine learning model.

11. The non-transitory machine readable storage medium of claim 10, wherein the bitmask is a first bitmask, and the instructions cause the programmable circuitry to generate a second bitmask having the kernel size, the second bitmask based on the first saliency score computed for the first pixel of the input image at which the first bitmask was applied to the input image.

12. The non-transitory machine readable storage medium of claim 10, wherein the input image has first dimensions, the bitmask is a matrix having second dimensions equivalent to the first dimensions, and the instructions cause the programmable circuitry to:
compute a candidate score for the first pixel, the candidate score corresponding to an objective function for the first pixel; and
when the candidate score satisfies a current value of an objective function threshold, populate the matrix to generate the bitmask, the matrix including a kernel having the kernel size, the kernel centered at first coordinates of the matrix that match second coordinates of the first pixel, first values within the kernel being non-zero, second values outside of the kernel being zero.

13. The non-transitory machine readable storage medium of claim 12, wherein the kernel is a Gaussian kernel.

14. The non-transitory machine readable storage medium of claim 10, wherein the input image has first dimensions, the bitmask is a matrix having second dimensions equivalent to the first dimensions, the matrix includes a kernel having the kernel size, the kernel centered at first coordinates of the matrix that match second coordinates of the first pixel, and the instructions cause the programmable circuitry to compute a Hadamard product between the input image and the matrix to apply the bitmask to the input image.

15. The non-transitory machine readable storage medium of claim 10, wherein the kernel size is a first kernel size, the saliency map is a first saliency map generated for first bitmasks having the first kernel size, and the instructions cause the programmable circuitry to aggregate the first saliency map with a second saliency map to generate a composite saliency map for the input image, the second saliency map generated for second bitmasks having a second kernel size different than the first kernel size.

16. The non-transitory machine readable storage medium of claim 10, wherein the instructions cause the programmable circuitry to compute the second saliency score based on a task to be achieved by the machine learning model.

17. The non-transitory machine readable storage medium of claim 10, wherein the instructions cause the programmable circuitry to generate the saliency map without accessing any of parameters of the machine learning model, features identified by the machine learning model, or gradients corresponding to the machine learning model.

18. The non-transitory machine readable storage medium of claim 10, wherein the at least one feature corresponds to at least one of the one or more pixels of the input image.

19. A method comprising:
generating, by utilizing an instruction with programmable circuitry, a bitmask having a kernel size;
applying, by utilizing an instruction with the programmable circuitry, the bitmask to an input image to generate a first masked input image, the input image including one or more pixels;
computing, by utilizing an instruction with the programmable circuitry, a first saliency score for a first pixel of the input image based on the first masked input image;
computing, by utilizing an instruction with the programmable circuitry, a second saliency score for a second pixel of the input image based on an output generated by a machine learning model, the output based on a second masked input image; and
generating, by utilizing an instruction with the programmable circuitry, a saliency map for the input image based on the first saliency score and the second saliency score, the saliency map indicative of at least one feature of the input image that contributed to training of the machine learning model.

20. The method of claim 19, wherein the bitmask is a first bitmask, and the method further includes generating a second bitmask having the kernel size, the second bitmask based on the first saliency score computed for the first pixel of the input image at which the first bitmask was applied to the input image.

21.-27. (canceled)
